(19) United States
(12) Patent Application Publication
(10) Pub. No.: US 2017/0249096 A1
(43) Pub. Date: Aug. 31, 2017

(54) DATA SAVING UPON INTERRUPTION OF POWER SUPPLY TO A STORAGE DEVICE

(71) Applicant: KABUSHIKI KAISHA TOSHIBA, Tokyo (JP)

(72) Inventor: Tadashi HONGAWA, Kawasaki Kanagawa (JP)

(21) Appl. No.: 15/253,786

(22) Filed: Aug. 31, 2016

(30) Foreign Application Priority Data
Feb. 29, 2016 (JP) 2016-036857

(51) Int. Cl. G06F 3/06; G06F 9/44

(52) U.S. Cl. CPC G06F 3/0625; G06F 3/0679; G06F 3/0655; G06F 3/0619; G06F 3/0607; G06F 9/4401

(57) ABSTRACT

A storage device includes a nonvolatile storage, a volatile memory, a nonvolatile memory that is accessible faster than the nonvolatile storage, and a controller circuit. The controller circuit is configured to select one or more types of updated management information that is stored in the volatile memory and not yet saved in the nonvolatile storage, based on a recovery time associated with each type of updated management information, and in response to interruption of power supply to the storage device from an external power source, carry out data saving of said selected types of updated management information to the nonvolatile memory.

### CROSS-REFERENCE TO RELATED APPLICATION

This application is based upon and claims the benefit of priority from Japanese Patent Application No. 2016-036857, filed Feb. 29, 2016, the entire contents of which are incorporated herein by reference.

### FIELD

Embodiments described herein relate generally to a storage device and a method for operating the same.

### BACKGROUND

A storage device, for example, a magnetic disk device, uses management information such as system information for the operation thereof. The system information is used by a system (for example, a controller of the magnetic disk device) to perform management (for example, management of data written to the disk). The system information is stored in a volatile memory such as a dynamic RAM (DRAM) in order to increase the processing speed of the system. The system information stored in the volatile memory may be lost due to an interruption (power interruption) of power supplied to the magnetic disk device from a primary power source.

In the related art, various method are proposed in order to avoid loss of data caused by a power interruption, that is, in order to protect the data upon a power interruption. One method would be saving data stored in the volatile memory (for example, write data unwritten to the disk) to a nonvolatile memory such as a flash ROM using a backup power source upon the power interruption. This data protection method is also referred to as power loss protection (PLP).

### DESCRIPTION OF THE DRAWINGS

FIG. 1 is a block diagram illustrating a configuration of a magnetic disk device according to an embodiment.

FIG. 2 illustrates a memory map of a buffer area of a DRAM in the magnetic disk device illustrated in FIG. 1.

FIG. 3 illustrates an example of mapping in a CPU memory space of a system buffer area of the DRAM illustrated in FIG. 2.

FIG. 4 illustrates a memory map of a save area of an FROM in the magnetic disk device illustrated in FIG. 1.

FIG. 5 illustrates a data structure of a system buffer management table stored in the magnetic disk device illustrated in FIG. 1.

FIG. 6 illustrates a data structure of an FROM management table stored in the magnetic disk device illustrated in FIG. 1.

FIG. 7 illustrates a data structure of a save management table stored in the magnetic disk device illustrated in FIG. 1.

FIG. 8 is a flowchart illustrating a procedure of a system information saving process according to the embodiment.

FIG. 9 is a flowchart illustrating a procedure of a saving object determination process carried out during the system information saving process.

### DETAILED DESCRIPTION

If the PLP is employed to save the system information, not all system information in the volatile memory (more specifically, all types of system information) can be saved in the nonvolatile memory using power from the backup power source because of limited power capacity of the backup power source.

For that reason, if there is unsaved system information, the unsaved system information would be lost due to the power interruption. In this case, the controller of the magnetic disk device may have to recover the unsaved system information to a state immediately before the power interruption when the magnetic disk device is started again after the power interruption. The time necessary for this recovery of the system information mainly depends on the type of system information to be recovered.

The PLP is also employed in a storage device other than a magnetic disk device, such as a solid-state drive (SSD). Even if the PLP is employed in such a storage device, not all system information may be saved upon the power interruption.

An embodiment provides a storage device and a method for operating the same that can shorten the time necessary to recover unsaved management information after a power interruption.

According to an embodiment, a storage device includes a nonvolatile storage, a volatile memory, a nonvolatile memory that is accessible faster than the nonvolatile storage, and a controller circuit. The controller circuit is configured to select one or more types of updated management information that is stored in the volatile memory and not yet saved in the nonvolatile storage, based on a recovery time associated with each type of updated management information, and in response to an interruption of power supplied to the storage device from an external power source, carryout data saving of said selected types of updated management information to the nonvolatile memory.

Below, embodiments will be described with reference to the drawings.

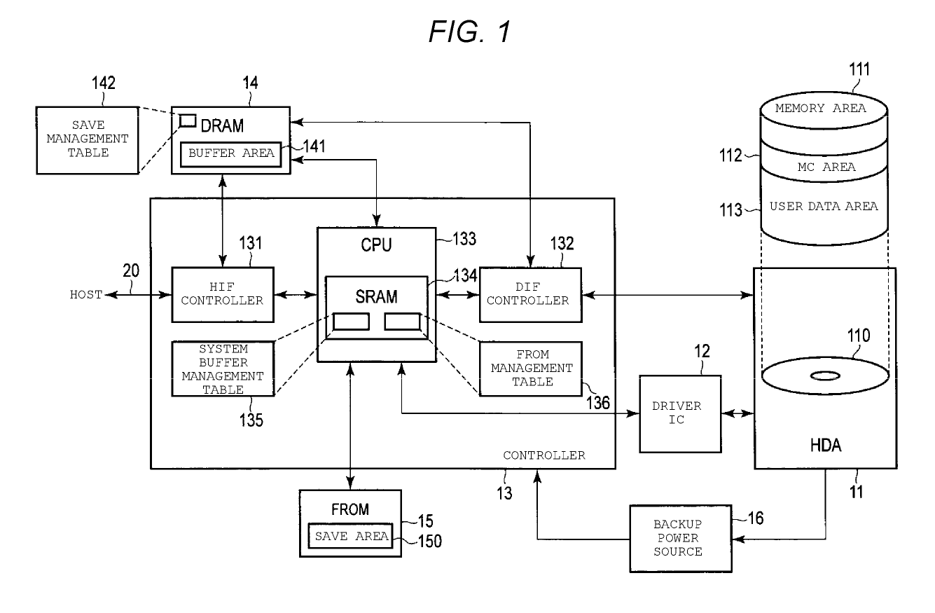

FIG. 1 is a block diagram illustrating a configuration of a magnetic disk device according to an embodiment. The magnetic disk device is an example of a storage device and is also referred to as a hard disk drive (HDD). In the following description, the magnetic disk device is denoted as the HDD. The HDD illustrated in FIG. 1 has a head disk assembly (HDA) 11, a driver IC 12, a controller 13, a DRAM 14, a flash ROM (FROM) 15, and a backup power source 16.

The HDA 11 includes a disk 110. The disk 110 is, for example, a nonvolatile storage having a recording surface, on which data are magnetically recorded on at least one surface side thereof. That is, the disk 110 includes a storage area 111. A portion of the storage area 111 is used as a media cache (MC) area 112 and another portion of the storage area 111 is used as a user data area 113. The user data area 113, for example, includes a plurality of concentric circular areas, which are referred to as bands. Each band is used as a data write-once access area.

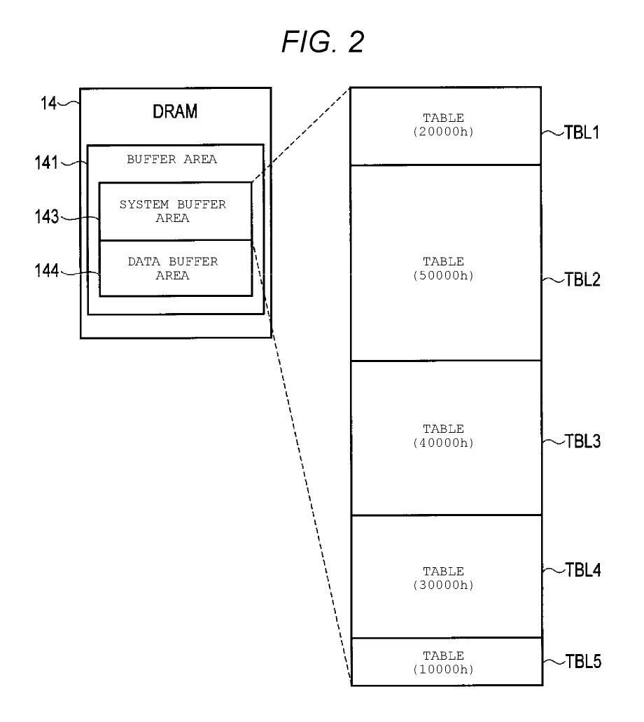

The MC area 112 is an area not accessible by a user (portion of a so-called system area). The MC area 112 is used for sequentially storing (saving) a portion (for example, randomly-accessed write data) of data into a data buffer area 144 (FIG. 2) in a buffer area 141 of the DRAM 14. The data buffer area 144 and the MC area 112 according to the present embodiment are used as a primary cache and a secondary cache, respectively. The user data area 113 is used, for example, for storing the write data specified by a write command from a host.

The HDA 11 further includes well-known mechanical elements, such as a head, a spindle motor (SPM), and an actuator. However, such elements are not illustrated in FIG. 1. The head is supported on a suspension and includes a read element and a write element. The width of the write element is larger than the width of the read element. The widths of the write element and the read element are widths in a direction orthogonal to the center line of the suspension. In the present embodiment, shingled magnetic recording is used for writing data in the disk 110. In the shingled magnetic recording, data are written in order from the header track to the final track in each band. The write element is moved in the radial direction of the disk 110 so that a portion of the write track overlaps by a pitch corresponding to the track (read track) traced by the read element each time data of one track are written to the band. Each band in which data have been written using the shingled magnetic recording contains a first track and a second track partially overlapping the first track. The SPM causes the disk 110 to rotate.

The driver IC 12 drives the SPM and the actuator according to control of the controller 13 (more specifically, a CPU 133 in the controller 13). The controller 13 is formed of, for example, a large-scale integrated circuit (LSI) referred to as a system-on-a-chip (SOC) in which a plurality of elements are integrated on a single chip. The controller 13 includes a host interface controller (HIF controller) 131, a disk interface controller (DIF controller) 132, and the CPU 133.

The HIF controller 131 is connected to a host device (host) via the host interface 20. The HIF controller 131 receives commands (such as write commands and read commands) transmitted from the host. The HIF controller 131 controls data transfer between the host and the DRAM 14.

The DIF controller 132 controls data transfer between the disk 110 and the DRAM 14. The DIF controller 132 includes a read/write channel (not illustrated). The read/write channel processes signals associated with reading/writing with respect to the disk 110. The read/write channel converts a signal (read signal) read from the disk 110 to digital data with an analog-to-digital converter and decodes read data from the digital data. The read/write channel extracts servo data necessary for positioning of the head from the digital data. The read/write channel encodes write data to be written to the disk 110. The read/write channel may be provided independently from the DIF controller 132. In this case, the DIF controller 132 may control the data transfer between the DRAM 14 and the read/write channel.

The CPU 133 is a processor that functions as a main controller of the HDD illustrated in FIG. 1. The CPU 133 controls at least an element of the HDD according to a control program. The element of the HDD may include the driver IC 12, the HIF controller 131, and the DIF controller 132, and the control program in the present embodiment is stored in advance in a specified storage area of the disk 110 or the FROM 15.

The CPU 133 includes an SRAM 134. The SRAM 134 is a volatile memory generally having a higher access speed than the DRAM 14. However, the DRAM 14 may be used instead of the SRAM 134. At least a portion of the control program is loaded to a portion of the storage area of the SRAM 134 (or DRAM 14) from the FROM 15 when power supply to the HDD from a main power source is started. The control program may be stored in advance in the disk 110 or a read-only nonvolatile memory (for example, a ROM) (not illustrated). At least a portion of the control program may not be necessarily loaded to the SRAM 134 (or DRAM 14).

Another portion of the storage area of the SRAM 134 is used for storing a system buffer management table 135 and an FROM management table 136. The tables 135 and 136 are stored in advance in a specified storage area of the disk 110 and loaded from the specified storage area to the SRAM 134 (or DRAM 14) during startup of the HDD. The tables 135 and 136 may be stored in advance in the FROM 15 or the ROM (not illustrated). The tables 135 and 136 are not necessarily loaded to the SRAM 134 (or DRAM 14).

A portion of the storage area of the DRAM 14 is used as the buffer area 141. A portion of the buffer area 141 is used as a system buffer area 143 (FIG. 2) for storing a group of system information (more specifically, a plurality of types of system information). Another portion of the buffer area 141 is used as the data buffer area 144 (FIG. 2) for storing data to be written in the disk 110 and data read from the disk 110. Another portion of the storage area of the DRAM 14 is used for storing a save management table 142. The save management table 142 is used to store management information pertaining to saving of the group of system information. The save management table 142 may be stored in the SRAM 134.

The FROM 15 is a rewritable nonvolatile memory. In the present embodiment, an initial program loader (IPL) is stored in advance in a portion of the storage area of the FROM 15. The CPU 133 loads at least a portion of the control program stored in another portion of the storage area of the FROM 15 or on the disk 110 to the SRAM 134, for example, by executing the IPL in response to power supply from the main power source to the HDD. The IPL, for example, may be stored in advance in the ROM.

Another portion of the storage area of the FROM 15 is used as a save area 150. The save area 150 is used for saving part of the information stored in the buffer area 141 of the DRAM 14 when the power supply from the main power source to the HDD is unexpectedly interrupted. The DRAM 14 and the FROM 15 may be provided inside the controller 13.

The backup power source 16 temporarily generates power in response to the interruption of the power supply (power interruption) to the HDD. The generated power is used for saving the part of the information stored in the buffer area 141 to the save area 150 of the FROM 15. In addition, in the present embodiment, the generated power is also used to retract the head to a location (a so-called ramp) apart from the disk 110.

FIG. 2 illustrates an example of a memory map of the buffer area 141 in the DRAM 14. The buffer area 141 includes, as described above, the system buffer area 143 and the data buffer area 144. The system buffer area 143 is used, for example, to store tables TBL1 to TBL5.

The tables TBL1 to TBL5 are used to store first to fifth types of system information (management information) for management of the HDD, respectively. In the present embodiment, the size of each table TBL1 to TBL5 (first to fifth type of system information) is determined in advance, and is denoted, as in brackets in FIG. 2, as 20000h, 50000h, 40000h, 30000h and 10000h, respectively. The unit of the size thereof is the byte and the suffix “h” indicates hexadecimal notation.

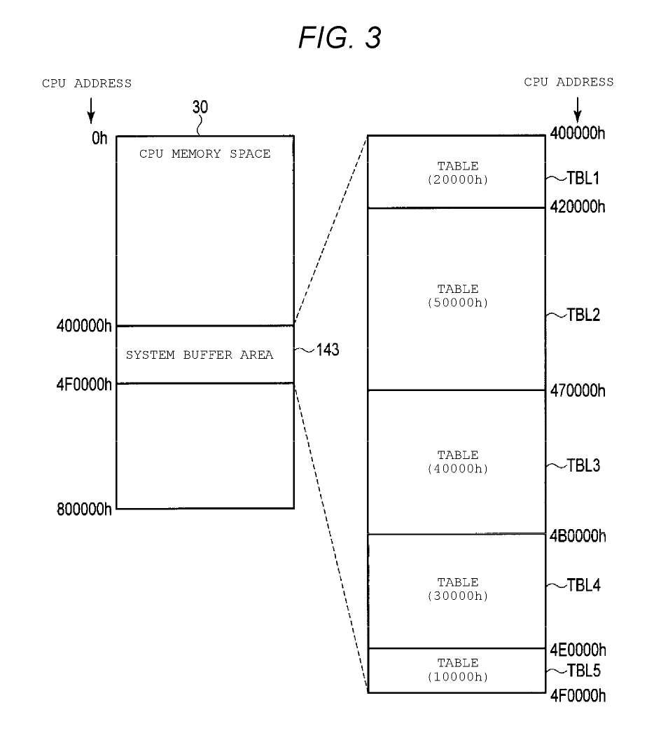

The system buffer area 143 is assigned to a specified address range of a memory space (that is, a CPU memory space 30 in FIG. 3) which is recognizable by the CPU 133. FIG. 3 illustrates an example of mapping of the system buffer area 143 in the CPU memory space. As illustrated in FIG. 3, the system buffer area 143 is assigned to an address range of 40000h to 4F0000h in the CPU memory space 30.

The size of the address range 40000h to 4F0000h is equal to the sum total (F0000h) of the size of the tables TBL1 to TBL5. Accordingly, the tables TBL1, TBL2, TBL3, TBL4, and TBL5 stored in the system buffer area 143 are assigned to the address ranges 40000h to 42000h, 42000h to 47000h, 47000h to 4B000h, 4B000h to 4E000h, and 4E000h to 4F000h, respectively, in the CPU memory space 30. In this case, the CPU 133 can access an entry of the table TBL1 stored in the system buffer area 143 by using a CPU address between 40000h and 42000h.

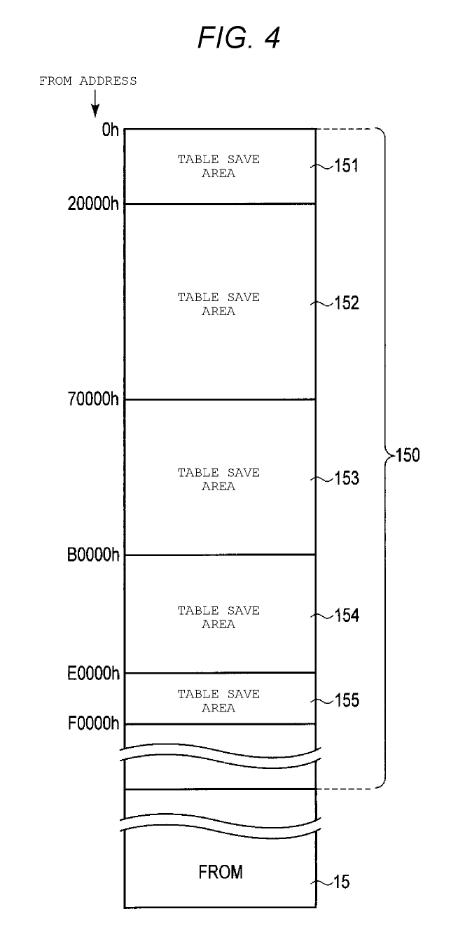

FIG. 4 illustrates an example of a memory map of the save area 150 in the FROM 15. The save area 150 includes table save areas 151 to 155 used in saving the table TBL1 to TBL5 in the DRAM 14 using the PLP functions. In the present embodiment, the range of addresses in the FROM 15 (that is, FROM address) for the table save areas 151, 152, 153, 154, and 155 are secured in the areas of 0h to 20000h, 20000h to 70000h, 70000h to B0000h, B0000h to E0000h, and E0000h to F0000h, respectively.

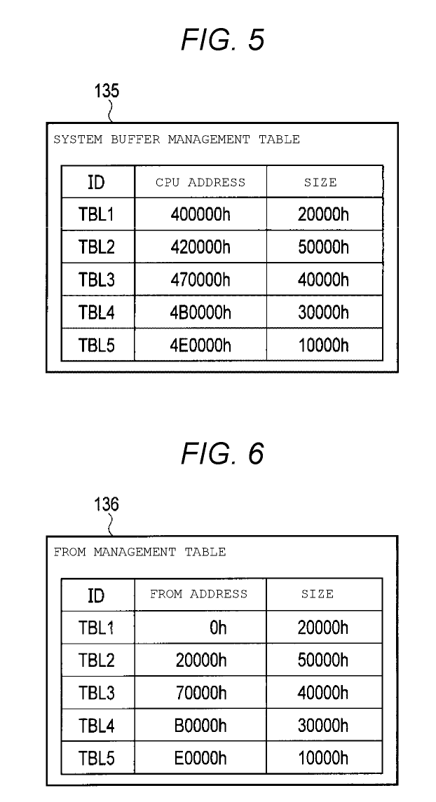

FIG. 5 illustrates a data structure of the system buffer management table 135. The system buffer management table 135 contains entries correlated with each of the tables TBL1 to TBL5. The i-th (i=1, 2, 3, 4, 5) entry of the system buffer management table 135 is used to store management information (system buffer management information) for managing a storage destination (mapping destination) of the table TBLi (i-th type of system information) in the CPU memory space 30 (that is, the CPU memory space 30 to which the system buffer area 143 is allocated).

The system buffer management information contains an identifier (ID) of the table TBLi, a CPU address, and size information. The CPU address indicates a head position of the CPU address range in the CPU memory space 30 to which the table TBLi (more specifically, the area in the DRAM 14 in which the table TBLi is stored) is assigned. The size information indicates the size of the CPU address range. The size is equal to the size of table TBLi.

FIG. 6 illustrates a data structure of the FROM management table 136. The FROM management table 136 contains entries correlated with the tables TBL1 to TBL5. The i-th entry of the FROM management table 136 is used to store management information (save destination management information) for managing the save destination of the table TBLi in the FROM 15. However, in the present embodiment, the save operation in which the PLP function is used may not be carried out for all of the tables TBL1 to TBL5, to save in the save destination managed by the FROM management table 136.

The save destination management information contains an ID of the table TBLi, an FROM address, and size information. The FROM address indicates a head position of the FROM address range of the FROM 15 used as the save destination of the table TBLi. The size information indicates the size of the FROM address range. The size is equal to the size of table TBLi.

In the present embodiment, the contents in the system buffer management table 135 and the FROM management table 136 are determined in advance by the control program, and are not updated. In the tables 135 and 136, the order of the entries correlated with the tables TBL1 to TBL5 is also determined in advance by the control program. Therefore, the CPU 133 can specify the entries correlated with the tables TBL1 to TBL5 in the tables 135 and 136 according to the control program. Accordingly, each entry in the tables 135 to 136 does not necessarily have the ID of the corresponding table.

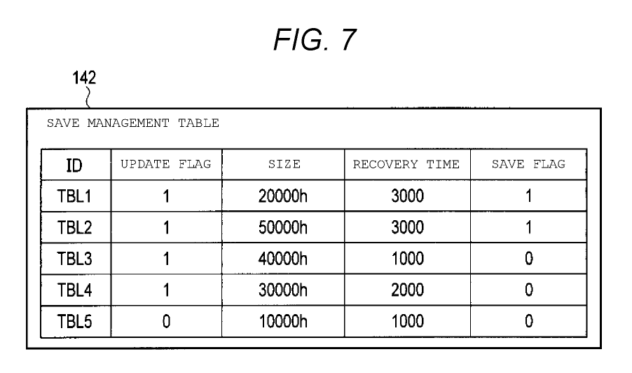

FIG. 7 illustrates a data structure of the save management table 142. The save management table 142 contains entries correlated with the tables TBL1 to TBL5. The i-th entry of the save management table 142 is used to store management information (save management information) for managing the saving of the table TBLi.

The save management information contains the ID of the table TBLi, an update flag, size information, recovery time information, and a save flag. The update flag indicates whether or not the table TBLi is updated and whether or not the updated table TBLi, if so updated, is saved to the disk 110. When the update flag indicates that the table TBLi is updated and not saved (that is, the updated table TBLi is not saved), the update flag also indicates that the table TBLi is a save candidate during a power interruption. The size information indicates the size of the table TBLi.

The recovery time information indicates time (recovery time) necessary to perform an operation of recovering the table TBLi to be executed during startup of the HDD if the table TBLi is not saved to the disk 110 at the time of the power interruption. The unit of the recovery time indicated in FIG. 7 is millisecond (ms). The recovery time of the table TBLi is mainly dependent on the type (more specifically, the type of system information held in the table TBLi) of the table TBLi and for example, is determined by a recovery time determination process. The save flag indicates whether or not the table TBLi is to be saved during a power interruption.

The save flag and the update flag are cleared in an initial state. In FIG. 7, the state in which each of the save flag and the update flag is set is indicated by “1”, and the state in which each of the save flag and the update flag are cleared is indicated by “0”.

Next, the recovery operation related to the recovery time will be described with a case of recovering the table TBLi as an example. In the present embodiment, the table TBLi (more specifically, the updated table TBLi) is stored in a specified area of the disk 110, as appropriate (for example, in the idle state of the HDD when access is not requested from the host). Here, it is assumed that a power interruption occurs before the table TBLi is saved to the disk 110 although the table TBLi is updated. In this case, if the updated table TBLi (that is, the newest table TBLi) is not saved, for example, in the FROM 15, the newest table TBLi will be lost. The update of the table TBLi is not reflected in the table TBLi (more specifically, the old table TBLi) saved in the specified area of the disk 110 prior to the update.

To prevent such a situation, the CPU 133 executes the recovery operation for recovering the table TBLi to a state immediately before the power interruption, during startup of the HDD. Here, it is assumed that the table TBLi is a table (below, referred to as an MC management table) for managing data (that is, randomly accessed write data) stored in the MC area 112. In this case, the table TBLi stores management information for managing the write data (random access write data) for each write command from the host. The management information contains a logical address (for example, a logical block address), the MC address, and size information. The logical block address indicates a logical position (that is, position recognized by the host) of a data region to store the header of the write data. The MC address indicates a physical position of the MC area 112 (that is, a position on the disk 110) to store the header of the write data. The size information indicates the size of the write data.

When the write data (random access write data) are stored in the MC area 112, the header is attached to the write data. The header contains a logical block address, an MC address, and size information similarly to the management information stored in the table TBLi.

In the recovery operation, the CPU 133 reads the data written to the MC area 112 after the table TBLi is most recently saved to the specified area of the disk 110. The CPU 133 recovers the table TBLi based on the header information attached to the read data.

For the recovery, it is necessary for the CPU 133 to detect a location (incomplete write point) on the MC area 112 at which data writing is incomplete due to the power interruption, using the read operation. An extended time may be needed in detection of the incomplete write point when the data written to the MC area 112 are random access write data as in the present embodiment. The main factors therefor are as follows.

When shingled magnetic recording is employed for the data writing in the disk 110 as in the embodiment, one track of the data are written so as to overlap a portion of a track on which data are previously written. That is, in shingled magnetic recording, a portion of the data on the adjacent track is lost due to overwriting. Therefore, the track (next track adjacent to the track during writing) that includes sectors of lost data is created in a portion of a band when a power interruption occurs before the data writing reaches the terminal end of the band. The DIF controller 132 repeats attempting data reading on the portion with the lost data many times. This is the reason that an extended time is necessary for detection of the incomplete write point.

The maximum or average time necessary for retrying (first time) and the maximum or average time necessary for binary searching (second time) can be calculated. For that reason, when the table TBLi is an MC management table, it is possible to determine (predict) the time necessary for recovery of the table TBLi based on the first time and the second time by the CPU 133 executing the recovery time determination process.

Next, it is assumed that the table TBLi is a management table (below, referred to as a bypass table) for managing a data stream and that each data stream is sequential data. In this case, the table TBLi stores management information for managing corresponding sequential data (sequential write data) for each data stream.

In the present embodiment, one of the tables TBL1 to TBL5 is the MC management table and another one of the tables TBL1 to TBL5 is the bypass table. The tables TBL1 to TBL5 do not include an address conversion table for managing the correspondence between the logical address of data (for example, the logical block address) and the physical address of the disk 110 at which the data are actually stored. The reason therefor is because the update frequency of the address conversion table applied in the HDD is comparatively low and, accordingly, in the present embodiment, the CPU 133 stores the updated address conversion table in a specified area of the disk 110 each time the address conversion table is updated. However, one of the tables TBL1 to TBL5 may be an address conversion table.

In the present embodiment, the power interruption may occur before writing of the plurality of data streams is completed. For example, write commands WC1 to WC8 are issued in order from the host to the HDD. The write data WD1, WD2, WD4, and WD7 specified by the write commands WC1, WC2, WC4, and WC7, respectively, are sequential and are written to the first area of the user data area 113 on the disk 110. The write data WD3 and WD5 specified by the write commands WC3 and WC5, respectively, are sequential and are written to the second area of the user data area 113 on the disk 110. Furthermore, the write data WD6 and WD8 specified by the write commands WC6 and WC8, respectively, are also sequential, and it is assumed that the power interruption occurs while the write data WD8 is being written to the third area of the user data area 113 of the disk 110.

In this case, if the table TBLi (that is, the newest table TBLi) is not saved, for example, in the FROM 15, the newest table TBLi will be lost. To prevent such a situation, the CPU 133 executes the recovery operation for recovering the table TBLi to a state immediately before the power interruption, during startup of the HDD.

In the above-described example, the CPU 133 searches the three data streams and recovers the table TBLi based on the header information attached to the three searched data streams. The CPU 133 detects the incomplete write point for the recovery. The maximum or average time necessary for searching the data streams is referred to as a third time. The maximum or average time necessary for detecting the incomplete write point is referred to as a fourth time. In this case, when the table TBLi is a bypass table, it is possible to determine the time necessary for recovery of the table TBLi based on the third time and the fourth time by the CPU 133 executing the recovery time determination process. Generally, the recovery time of the bypass table is longer than that of the MC management table. In the case of a bypass table, because it is necessary to prepare 100 or more data streams according to the usage, an extended time is necessary for recovery.

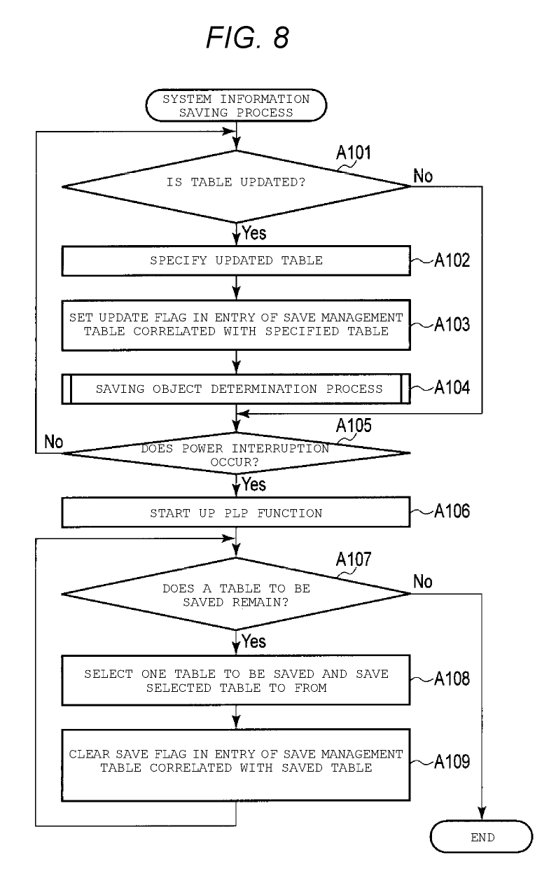

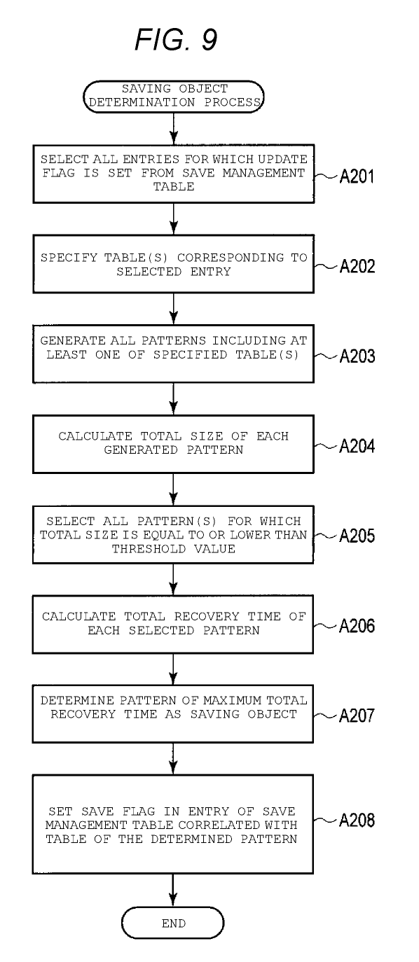

Next, an operation of the present embodiment, in particular, a system information saving process which includes a system information (table) save operation will be described with reference to FIGS. 8 and 9. FIG. 8 is a flowchart illustrating a procedure of the system information saving process. FIG. 9 is a flowchart illustrating a procedure of the saving object determination process included in the system information saving process.

First, the CPU 133 monitors the updating of the tables (in the present embodiment, the tables TBL1 to TBL5) managed using the save management table 142 and determines whether the update occurs with any of the tables TBL1 to TBL5 (A101). In the present embodiment, the CPU 133 also executes a table update. However, a CPU (processor) different from the CPU 133 may execute the table update.

If the table update is determined not to occur (No in A101), the CPU 133 determines whether the power supply from the main power source to the HDD is interrupted (A105). In the present embodiment, the CPU 133 determines that there is an interruption of the power supply (that is, a power interruption) when a power source voltage applied from the main power source to the HDD is below a fixed level (that is, threshold) for a fixed period or more. If no power interruption is determined to occur (No in A105), the process returns to A101.

Meanwhile, if the table update is determined to occur (Yes in A101), the CPU 133 specifies the updated table (A102). Here, the table TBLi is specified as the updated table. In this case, the CPU 133 sets the update flag in the entry of the save management table 142 correlated with the specified table TBLi (A103). In A103, the CPU 133 may calculate the time (recovery time) necessary for recovery of the specified (updated) table TBLi and update the recovery time information in the save management table 142 correlated with the table TBLi so as to indicate the calculated time. The update flag which is set is cleared, for example, when the table TBLi is saved in the specified area of the disk 110 during the idle state of the HDD.

Next, the CPU 133 executes the saving object determination process (A104). The saving object determination process includes processing for determining one or more tables to be saved in the save area 150 of the FROM 15 during the power interruption from the tables TBL1 to TBL5 managed by the save management table 142.

Here, the saving object determination process will be described with reference to FIG. 9. First, the CPU 133 refer to the save management table 142 and selects all entries for which the update flag is set from the save management table 142 (A201). In the save management table 142 illustrated in FIG. 7, the entries of the tables TBL1 to TBL4 are selected. In the save management table 142 illustrated in FIG. 7, the save flag is set in the entries correlated with the tables TBL1 and TBL2. However, when A201 is executed, the save flag is not set in the entry correlated with the tables TBL1 and TBL2.

Next, the CPU 133 specifies the table correlated with the selected entry (A202). For example, when the entries of tables TBL1 to TBL4 are selected, the tables TBL1 to TBL4 are specified.

Next, the CPU 133 generates all patterns that include one or more of the specified tables (A203). When the tables TBL1 to TBL4 are specified, patterns of a single table are the first to fourth patterns as follows. The first to fourth patterns include the tables TBL1 to TBL4, respectively. Here, the first to fourth patterns are denoted by patterns C1[TBL1] to C4[TBL4], respectively.

Patterns of two tables are the fifth to tenth patterns as follows. The fifth, sixth, and seventh patterns are a combination of the tables TBL1 and TBL2, a combination of the tables TBL1 and TBL3, and a combination of tables TBL1 and TBL4, respectively. The eighth, ninth, and tenth patterns are a combination of the tables TBL2 and TBL3, a combination of the tables TBL2 and TBL4, and a combination of tables TBL3 and TBL4, respectively. Here, the fifth, sixth, seventh, eighth, ninth, and tenth patterns are denoted by patterns C5[TBL1, TBL2], C6[TBL1, TBL3], C7[TBL1, TBL4], C8[TBL2, TBL3], C9[TBL2, TBL4], and C10[TBL3, TBL4], respectively.

Patterns of three tables are the eleventh to fourteenth patterns as follows. The eleventh, twelfth, thirteenth, and fourteenth patterns are a group of the tables TBL1 to TBL3, a group of the tables TBL1, TBL2, and TBL4, and a group of the tables TBL1, TBL3, and TBL4, and a group of the tables TBL2 to TBL4, respectively. Here, the eleventh, twelfth, thirteenth, and fourteenth patterns are denoted by patterns C11[TBL1, TBL2, TBL3], C12[TBL1, TBL2, TBL4], C13[TBL1, TBL3, TBL4], and C14[TBL2, TBL3, TBL4], respectively.

A pattern of four tables is a fifteenth pattern as follows. The fifteenth pattern is a group of the tables TBL1 to TBL4. Here, the fifteenth pattern is denoted by pattern C15 [TBL1, TBL2, TBL3, TBL4]. For the purpose of simplification, the first to fifteenth patterns are denoted by patterns C1 to C15, respectively.

When A203 is executed, the CPU 133 calculates the sum of the size of the one or more tables included in the corresponding pattern based on the save management table 142 for each of the patterns (A204). The total sizes corresponding to the patterns C1 to C15 are denoted by TS1_C1 to TS15_C15, respectively.

In the save management table 142 illustrated in FIG. 7, the sizes of the tables TBL1, TBL2, TBL3, and TBL4 are 20000h, 50000h, 40000h, and 30000h (bytes), respectively. In this case, TS1_C1 (=TS1_C1[TBL1]), TS2_C2 (=TS2_C2[TBL2]), TS3_C3 (=TS3_C3[TBL3]), and TS4_C4 (=TS4_C4[TBL4]) are also 20000h, 50000h, 40000h, and 30000h, respectively.

Next, TS5_C5 (=TS5_C5[TBL1, TBL2]), TS6_C6 (=TS6_C6[TBL1, TBL3]), and TS7_C7 (=TS7_C7[TBL1, TBL4]) are 20000h+50000h=70000h, 20000h+40000h=60000h, and 20000h+30000h=50000h, respectively. Next, TS8_C8 (=TS8_C8[TBL2, TBL3]), TS9_C9 (=TS9_C9[TBL2, TBL4]), and TS10_C10 (=TS10_C10[TBL3, TBL4]) are 50000h+40000h=90000h, 50000h+30000h=80000h, and 40000h+30000h=70000h, respectively.

Next, TS11_C11 (=TS11_C11[TBL1, TBL2, TBL3]), TS12_C12 (=TS12_C12[TBL1, TBL2, TBL4]), TS13_C13 (=TS13_C13[TBL1, TBL3, TBL4]), and TS14_C14 (=TS14_C14[TBL2, TBL3, TBL4]) are 20000h+50000h+40000h=B0000h, 20000h+50000h+30000h=A0000h, 20000h+40000h+30000h=90000h, and 50000h+40000h+30000h=C0000h, respectively. TS15_C15 (=TS15_C15 [TBL1, TBL2, TBL3, TBL4]) is 20000h+50000h+40000h+30000h=E0000h.

Next, the CPU 133 detects total sizes equal to or smaller than a threshold from the total sizes TS1 to TS15 and selects all patterns corresponding to the detected total sizes (A205). The threshold indicates the size of information that can be saved to the save area 150 of the FROM 15 from the system buffer area 143 of the DRAM 14 within the time (backup enabled time) at which power can be supplied from the backup power source 16. In the present embodiment, the size threshold is 80000h. In this case, since the total size of the size threshold or lower is TS1_C1 to TS7_C7, TS9_C9, and TS10_C10, the CPU 133 selects the patterns C1 to C7, C9, and C10.

Next, the CPU 133 calculates the sum of the recovery times of the one or more tables included in the corresponding patterns based on the save management table 142 for each of the selected patterns (A206). The total recovery times corresponding to the patterns C1 to C7, C9, and C10 is denoted by TRP1_C1 to TRP7_C7, TRP9_C9, and TRP10_C10, respectively.

In the save management table 142 illustrated in FIG. 7, the recovery times of the tables TBL1, TBL2, TBL3, and TBL4 are 3000, 3000, 1000, and 2000 (ms), respectively. In this case, TRP1_C1 (=TRP1_C1[TBL1]), TRP2_C2 (=TRP2_C2[TBL2]), TRP3_C3 (=TRP3_C3[TBL3]), and TRP4 C4 (=TRP4_C4[TBL4]) are also 3000, 3000, 1000, and 2000, respectively.

Next, TRP5_C5 (=TRP5_C5 [TBL1, TBL2]), TRP6 C6 (=TRP6_C6 [TBL1, TBL3]), and TRP7_C7 (=TRP7_C7 [TBL1, TBL4]) are 3000+3000=6000, 3000+1000=4000, and 3000+2000=5000, respectively. TRP9_C9 (=TRP9_C9[TBL2, TBL4]) and TRP10_C10 (=TRP10_C10[TBL3, TBL4]) are 3000+2000=5000 and 1000+2000=3000, respectively.

Next, the CPU 133 detects the greatest total recovery time from the total recovery times TRP1_C1 to TRP7_C7, TRP9_C9, and TRP10_C10 (A207). In A207, the CPU 133 determines the pattern corresponding to the total recovery time detected as the saving object to be saved to the save area 150 of the FROM 15 during the power interruption. In the above-described example, since TRP5_C5 is the greatest, the CPU 133 determines the pattern C5 ([TBL1, TBL2]) as the saving object. That is, the CPU 133 determines the tables TBL1 and TBL2 corresponding to the pattern C5 ([TBL1, TBL2]) as the saving object.

Next, the CPU 133 sets the save flag in one or more entries (first entry) in the save management table 142 correlated with one or more tables corresponding to the determined pattern (A208). In the above-described example, the CPU 133 sets the save flag in the entries of the save management table 142 correlated with tables TBL1 and TBL2 (A208). FIG. 7 illustrates content of the save management table 142 executed in A208.

Here, it is assumed that the save flag has been already set in one or more entries of the save management table 142 before the saving object determination process (A104 in FIG. 8) is started. The one or more entries for which the save flag has been already set include a second entry other than the first entry. Such a state may occur due to the saving object determination process according to the previous table update (Yes in A101 in FIG. 8). When the save flag has been already set in the second entry, in A208, the CPU 133 clears the save flag already set in the second entry. The CPU 133 may clear all save flags in the save management table 142, for example, at the beginning of the saving object determination process.

When A208 is executed, the CPU 133 finishes the saving object determination process (A104 in FIG. 8) according to the flowchart in FIG. 9 and proceeds to A105 (FIG. 8). As described above, in A105, the CPU 133 determines whether the power interruption occurs. If no power interruption is determined to occur (No in A105), the process returns to A101.

In contrast, if the power interruption is determined to occur (Yes in A105), the CPU 133 starts the PLP function (A106). Then, the backup power source 16 generates power. In the present embodiment, the backup power source 16 uses SPM counter electromotive force to generate power. In this case, at least a portion of the backup power source 16 may be installed in the driver IC 12. However, the backup power source 16 may generate power using a capacitor charged by the power source voltage applied to the HDD.

The power generated by the backup power source 16 is supplied to at least the driver IC 12, the controller 13, the DRAM 14, and the FROM 15 in the HDD. However, the pathway for supplying power from the backup power source 16 to the driver IC 12, the DRAM 14, and the FROM 15 is not illustrated in FIG. 1.

The CPU 133 receives power generated by the backup power source 16 and continues the system information saving process. First, the CPU 133 determines whether a table to be saved remains based on whether an entry for which the save flag is set is included in the save management table 142 (A107). If a table to be saved remains (Yes in A107), the CPU 133 selects one table to be saved and saves the selected table to the save area 150 of the FROM 15 (A108). The details of A108 will be described below.

First, the CPU 133 selects the table correlated with an entry of the save management table 142, which is specified as having the save flag set therefor. Next, the CPU 133 specifies a first address range (more specifically, an address range in the CPU memory space 30) in the system buffer area 143 in which the selected table is stored, based on the entry in the system buffer management table 135 correlated with the selected table. The CPU 133 specifies a second address range in the save area 150 in which the selected table is to be saved, based on the entry in the FROM management table 136 correlated with the selected table.

Next, the CPU 133 reads (the system information held in) the selected table from the area included in the system buffer area 143 of the DRAM 14 and mapped to the first address range. The CPU 133 saves the read table to the second address range in the save area 150 of the FROM 15. Thereafter, the CPU 133 finishes A108.

Then, the CPU 133 clears the save flag in the entry of the save management table 142 correlated with the saved table (A109). Then, the process returns to A107. If a table to be saved still remains (Yes in A107), the CPU 133 again executes A108 and A109 and then the process returns to A107. In contrast, if no table to be saved remains (No in A107), the CPU 133 finishes the system information saving process.

In the save management table 142 illustrated in FIG. 7, the tables TBL1 and TBL2 are selected as the tables to be saved (A108). In this case, the tables TBL1 and TBL2 are saved to the table save areas 151 and 152, respectively, in the FROM 15. The CPU 133 loads the tables TBL1 and TBL2 saved to the table save areas 151 and 152 to the system buffer area 143 of the DRAM 14, by referring to the system buffer management table 135 and the FROM management table 136, when the HDD is started in response to restart of the power supply to the HDD.

In FIG. 7, the tables TBL3 to TBL5 are not saved in the FROM 15. Moreover, the tables TBL3 and TBL4 are updated. In this case, the CPU 133 executes the recovery operation for recovering the tables TBL3 and TBL4 to a state immediately before the power interruption, during startup of the HDD. The time necessary to recover the tables TBL3 and TBL4 is approximately 1,000+2,000=3,000 (ms) as is clear from FIG. 7.

In contrast, different to the present embodiment, it is assumed that the tables TBL3 and TBL4 are saved to the table save areas 153 and 154 of the FROM 15 in response to the power interruption, and the tables TBL1 and TBL2 are recovered during startup of the HDD. In this case, the time necessary to recover the tables TBL1 and TBL2 would be approximately 3,000+3,000=6,000 (ms), which is longer than the time required in the present embodiment.

In this way, according to the present embodiment, the CPU 133 saves one or more tables for which a long time is necessary for recovery to the FROM 15 in response to the power interruption. Thus, it is possible to shorten the time necessary to recover the unsaved table (system information) that is updated, during startup of the HDD (that is, the time necessary for start up of the HDD).

In the present embodiment, the FROM management table 136 is determined in advance. That is, table save area in the FROM 15 used in saving the tables TBL1 to TBL5 is determined in advance. However, the tables actually saved to the FROM 15 are a portion of the tables TBL1 to TBL5.

The CPU 133 may sequentially save the table to be saved to the save area 150. However, the relationship between the table to be saved and the save destination of the table is not determined in advance. Therefore, the CPU 133, for example, may generate the FROM management table 136 pertaining to the table to be saved after A207 or after A208 in FIG. 9.

Since the content of the generated FROM management table 136 is not fixed, it is necessary for the table 136 to be saved. The CPU 133, for example, may save the FROM management table 136 from the head position of the save area 150 immediately after A106 or immediately after A107 in FIG. 8. When the generated FROM management table 136 contains only the entry correlated with the table to be saved, the size of the table 136 changes in response to the number of tables to be saved. In this case, the CPU 133 may attach a header indicating the size of the FROM management table 136 to the table 136.

In the present embodiment, A101 to A105 (FIG. 8) in fact correspond to preprocessing of the system information saving process. Accordingly, the preprocessing (A101 to A105) may be carried out independently from the system information saving process. In this case, the system information saving process corresponds to A106 to A109.

In the present embodiment, shingled magnetic recording is employed in writing of data to the disk 110. However, shingled magnetic recording is not necessarily employed. Also, in the embodiment, the storage device is an HDD. However, the storage device may be a semiconductor drive unit such as an SSD which includes a nonvolatile memory which includes a group of nonvolatile memories (for example, NAND memory).

When the storage device is, for example, an SSD, the tables TBL1 to TBL5 include an address conversion table, a read count table, and a read threshold table. The read count table is used for storing a read count for each block (or page). The read count is a count value used for counter measures for read disturbance (RD). The read disturbance is a situation in which a value (or a threshold voltage) of a memory cell proximate to memory cell being read is changed by the data reading. The read threshold table is used for storing the read threshold (value of the threshold voltage) for each block (or page). If the recovery time of the address conversion table, the read count table, and the read threshold table are denoted as RTa, RTb, and RTc, respectively, the relationship RTa>RTb>RTc is generally satisfied.

According to at least one embodiment described above, it is possible to shorten the time necessary to recover the unsaved system information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a nonvolatile storage;
a volatile memory;
a nonvolatile memory that is accessible faster than the nonvolatile storage; and
a controller circuit configured to
select one or more types of updated management information that is stored in the volatile memory and not yet saved in the nonvolatile storage, based on a recovery time associated with each type of updated management information, and
in response to interruption of power supply to the storage device from an external power source, carry out data saving of said selected types of updated management information to the nonvolatile memory.

2. The storage device according to claim 1, further comprising:
an internal power source capable of supplying power during the interruption of power supply, wherein
the controller carries out the data saving using power from the internal power source.

3. The storage device according to claim 1, wherein
the controller selects said one or more types of updated management information, such that a total size thereof is smaller than a particular value.

4. The storage device according to claim 3, wherein
the controller selects said one or more types of updated management information, such that a total recovery time thereof is the largest of all patterns of total recovery times of one or more types of updated management information of which total size is smaller than the particular value.

5. The storage device according to claim 1, wherein
the recovery time of said each type of updated management information corresponds to a time required to recover the corresponding updated management information using data stored in the nonvolatile storage after the interruption of power supply ends.

6. The storage device according to claim 1, wherein
the controller is further configured to set an update flag in an entry of a management table corresponding to a type of management information, upon update thereof, and
said one or more types of updated management information are selected based on the update flag.

7. The storage device according to claim 6, wherein
the controller is further configured to set a save flag in the entry of the management table corresponding to each of said one or more selected types of updated management information, and clear the set save flag upon completion of saving of the corresponding updated management information in the nonvolatile memory.

8. The storage device according to claim 1, wherein
the controller selects said one or more types of updated management information in response to updating a type of management information stored in the volatile memory.

9. The storage device according to claim 1, wherein
when the storage device is booted after the interruption of power, the controller loads one or more types of updated management information saved in the nonvolatile memory to the volatile memory, and carries out data recovery with respect to one or more types of updated management information not saved in the nonvolatile memory, if any, using data stored in the nonvolatile storage.

10. The storage device according to claim 1, wherein
the nonvolatile storage is a magnetic disk.

11. A method for operating a storage device including a nonvolatile storage, a volatile memory, and a nonvolatile memory that is accessible faster than the nonvolatile storage, the method comprising:
selecting one or more types of updated management information that is stored in the volatile memory and not yet saved in the nonvolatile storage, based on a recovery time associated with each type of updated management information; and
in response to interruption of power supply to the storage device from an external power source, carrying out data saving of said selected types of updated management information to the nonvolatile memory.

12. The method according to claim 11, wherein
the data saving is carried out using power from an internal power source of the storage device, the internal power source being capable of supplying power during the interruption of power supply.

13. The method according to claim 11, wherein
said one or more types of updated management information are selected such that a total size of the selected types of updated management information is smaller than a particular value.

14. The method according to claim 13, wherein
said one or more types of updated management information are selected such that such that a total recovery time thereof is the largest of all patterns of total recovery times of one or more types of updated management information of which total size is smaller than the particular value

15. The method according to claim 11, wherein
the recovery time of said each type of updated management information corresponds to a time required to recover the corresponding updated management information using data stored in the nonvolatile storage after the interruption of power supply ends.

16. The method according to claim 11, further comprising:
setting an update flag in an entry of a management table corresponding to a type of management information, upon update thereof, wherein
said one or more types of updated management information are selected based on the update flag.

17. The method according to claim 16, further comprising:
setting a save flag in the entry of the management table corresponding to each of said one or more selected types of updated management information; and
clearing the set save flag upon completion of saving of the corresponding updated management information in the nonvolatile memory.

18. The method according to claim 11, wherein
selection of said one or more types of updated management information is carried out in response to updating a type of management information stored in the volatile memory.

19. The method according to claim 11, further comprising:
when the storage device is booted after the interruption of power, loading one or more types of updated management information saved in the nonvolatile memory to the volatile memory, and carrying out data recovery with respect to one or more types of updated management information not saved in the nonvolatile memory, if any, using data stored in the nonvolatile storage.

20. The method according to claim 11, wherein
the nonvolatile storage is a magnetic disk.
